(19) United States
(12) Patent Application Publication
(10) Pub. No.: US 2017/0070532 A1
(43) Pub. Date: Mar. 9, 2017

(54) AUTOMATED DETECTION OF UNAUTHORIZED UNINSTALL OPERATIONS

(71) Applicant: PILIXO LIMITED, DUBLIN 2 (IE)

(72) Inventor: Eugene Manko, Three Kings (NZ)

(21) Appl. No.: 14/844,508

(22) Filed: Sep. 3, 2015

(51) Int. Cl. H04L 29/06; G06F 21/12; G06F 21/62; H04L 12/24; H04L 29/08

(52) U.S. Cl. CPC H04L 63/1466; H04L 41/20; H04L 67/10; H04L 67/306; H04L 63/1416; H04L 63/1425; G06F 21/6218; G06F 21/121; G06F 2221/0717

(57) ABSTRACT

Network security and optimization requires user compliance with administrative actions controlled centrally from a server or administrator device to update and/or modify various user computing devices operating on the network. One example of operation may include identifying a diverting action performed via a computing device managed by an administrator device on a computer network, determining the diverting action is related to a software application currently operating on the computing device, transmitting a notification to the administrator device responsive to identifying the diverting action and responsive to determining the software application is currently operating on the computing device.

### TECHNICAL FIELD OF THE APPLICATION

This application relates to identifying certain uninstall events initiated on computer devices operating on a communication network, and more particularly, to intercepting the attempts to uninstall or bypass software installs and performing preemptive actions responsive to unauthorized attempts.

### BACKGROUND OF THE APPLICATION

Conventionally, computing devices operating on a communication network may be subject to frequent software upgrades, installs, modifications, etc., all of which are managed centrally from an administrator machine or server which delegates the software to the various computing devices operating on the network.

The users operating such devices may be interfering with the intended updates delegated from the network administrator. For example, a user may refuse to allow an upgrade to occur or may turn-off virus scan activities and/or other software applications which the user may find cumbersome when operating the computing device. Also, a user may uninstall certain applications altogether to avoid having that application interfere with their use of the computing device. These actions taken by a user may be unwarranted and against enterprise policies. Furthermore, the user's actions may be detrimental to the safety of the entire network and should be identified and circumvented to avoid damage to the rest of the network users.

### SUMMARY OF THE APPLICATION

One example embodiment may provide a method that includes at least one of identifying a diverting action performed via a computing device managed by an administrator device on a computer network, determining the diverting action is related to a software application currently operating on the computing device, transmitting a notification to the administrator device responsive to identifying the diverting action and responsive to determining the software application is currently operating on the computing device.

Another example embodiment may include an apparatus that includes at least one of a processor configured to identify a divert action performed via a computing device managed by an administrator device on a computer network, determine the divert action is related to a software application that currently operates on the computing device and a transmitter configured to transmit a notification to the administrator device responsive to the diverting action being identified and responsive to a determination that the software application currently operates on the computing device.

Yet another example embodiment may include a non-transitory computer readable storage medium configured to store instructions that when executed cause a processor to perform at least one of identifying a diverting action performed via a computing device managed by an administrator device on a computer network, determining the diverting action is related to a software application currently operating on the computing device, and transmitting a notification to the administrator device responsive to identifying the diverting action and responsive to determining the software application is currently operating on the computing device.

### BRIEF DESCRIPTION OF THE DRAWINGS

FIG. 1 illustrates an example install operation being conducted on a communication network according to example embodiments.

FIG. 2 illustrates an example communication network uninstall configuration according to example embodiments of the present application.

FIG. 3 illustrates a system signaling diagram of a communication event during an uninstall operation according to example embodiments.

FIG. 4 illustrates an example uninstall data logic diagram according to example embodiments of the present application.

FIG. 5 illustrates an example application management platform according to the present application.

FIG. 6 illustrates an example network entity device configured to store instructions, software, and corresponding hardware for executing the same, according to example embodiments of the present application.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

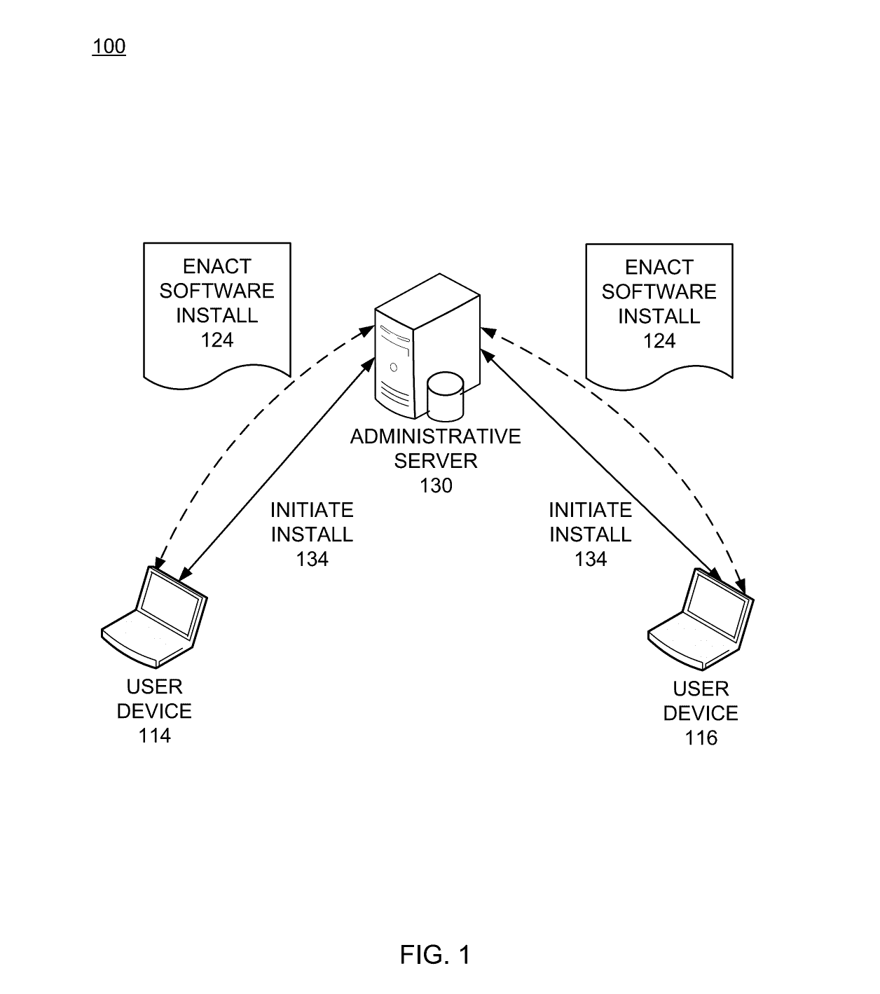

FIG. 1 illustrates an example install operation being conducted on a communication network according to example embodiments. Referring to FIG. 1, the network 100 includes an administrative server 130 operating as a management device that delegates work to multiple network devices operating on the network. For instance, the server 130 may be setup to execute a software install and/or upgrade to the various user devices 114 and 116. The install may be initiated as a script or message with various instructions 134. The devices may initiate their install routines at the prescribed times by enacting the script to install the software 124. The devices may also confirm receipt of the install and notify the server 130 when the install is complete or if any errors occur during the process. The server 130 may maintain a user profile for each user device to ensure the latest software upgrades and applications are updated accordingly.

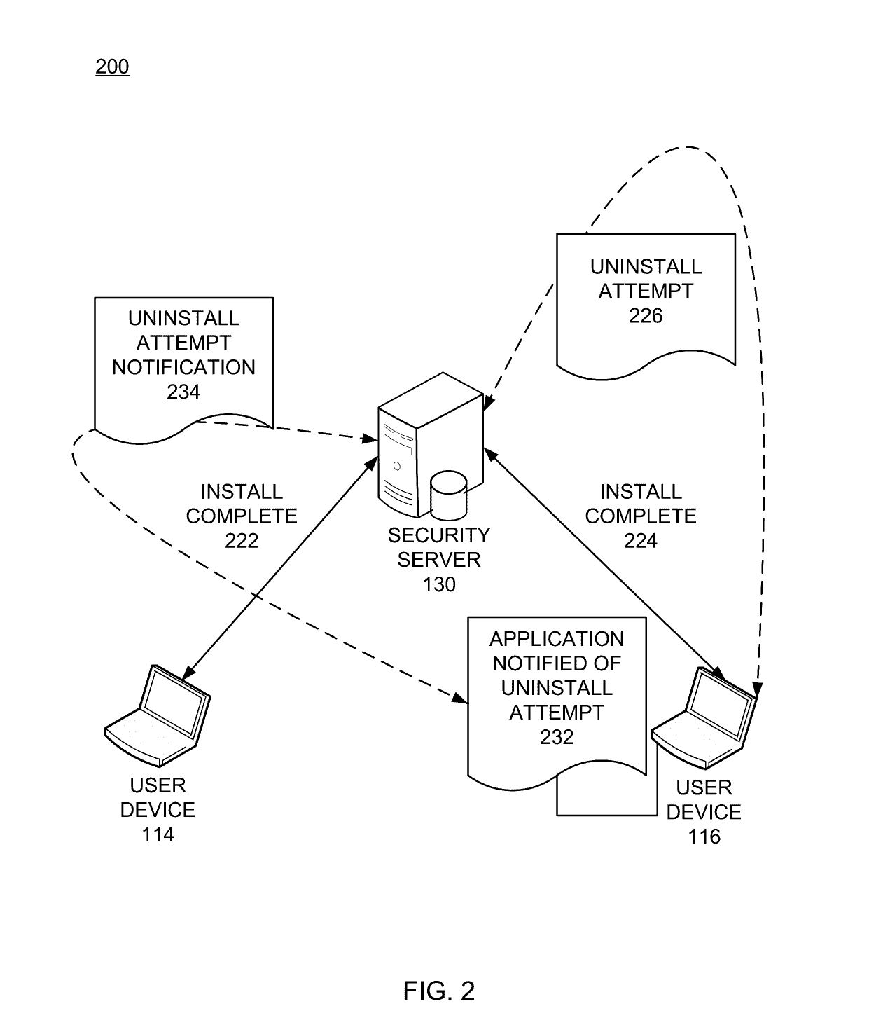

FIG. 2 illustrates an example communication network uninstall configuration according to example embodiments of the present application. Referring to FIG. 2, in this network example 200, the device 114 may notify the server 130 when the install operation is complete 222. Also, the other user device 116 may transmit a confirmation of the install operation 224. However, in this example, the uninstall attempt 226 conducted subsequently on the user device 116 may be unwarranted and against the policies of the administrator. Therefore, the uninstall attempt may be identified by the server 130 and the application being uninstalled may be notified to determine if the application is active 232. In the event that the application is operating, an uninstall attempt notification 234 may be generated and transmitted to the security server 130.

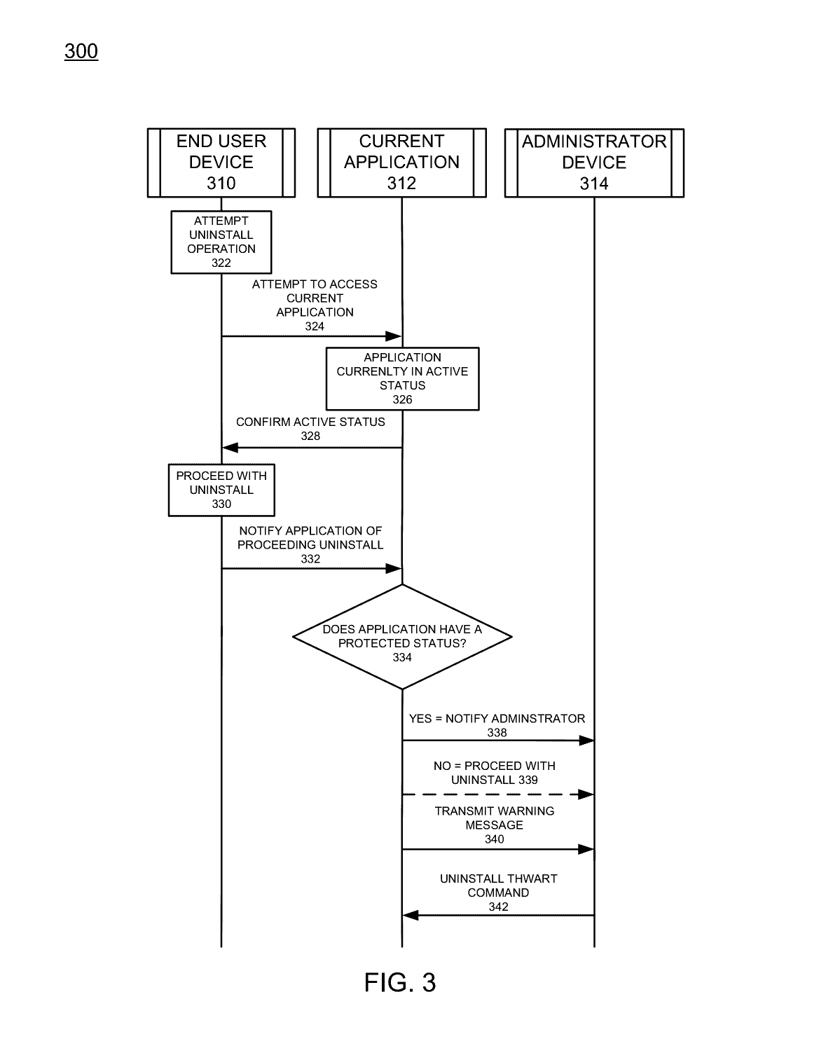

FIG. 3 illustrates a system signaling diagram of a communication event during an uninstall operation according to example embodiments. Referring to FIG. 3, the system configuration 300 includes an end user device 310, a current application 312 operating on the end user device and an administrator device 314. The process may initiate by a user device initiating an uninstall operation attempt 322, the attempt would trigger an application status determination that attempts to access the application being installed to determine whether the application is currently operating or is in a dormant state 324. The current application 312 may then report that it is currently active and operating as a live process 326. The status 328 may be shared with the end user device 310 which can then proceed with the uninstall operation 330. The uninstall operation then after being authorized to proceed, creates a notification that is sent to the current application 332. The application may determine whether that application has a protected status flag or not 334, and if so, the administrator device 314 is notified 338 immediately and in real-time. If the application is not a protected status application 339 then the uninstall operation may proceed without any further delay. A warning message 340 can be created and sent to the administrator 314. The administrator device 314 can then respond with a thwart command 342 that eliminates the current application from being uninstalled and/or reinstalls the application promptly following an uninstall.

A software product may be installed to achieve certain desirable properties. For instance, the enterprise is attempting to install common policy compliance software. However, some employees may decide that they do not like the product and simply uninstall it at their first opportunity. By requiring the application to be operating prior to an uninstall operation from being conducted reduces the chances of a user secretly removing an application. The software may be installed such that a regular user with regular access privileges (non-administrator) has no access to removing the directory or the files of the product. The user may still remove the product by accessing the Add/Remove software function, such as those included in WINDOWS operating systems.

According to example embodiments, if an administrator configured the server to prevent uninstalls then the process will generate an additional message to the client device to prevent an uninstall altogether. It may be that the administrator is only interested in knowing that a device attempted a software uninstall and the administrator can then manually mitigate the situation. In general, there are four remedies including reinstall, thwart uninstall, talk to the device owner and/or report the action to a superior.

Detecting an uninstall operation may be performed by establishing a hook to a particular API and then controlling the process of the uninstall, such as sending an example message to the server “application A uninstall on device B, can I proceed?” followed by the server response “yes” or “no”. However, additional options may be to include a “reinstall” policy so administrators may select which policy (i.e., stop or reinstall) is best suited and in this case the server answer to the above question would be “yes” or “no” or “reinstall”.

One example embodiment may include identifying a diverting action performed via a computing device managed by an administrator device on a computer network, determining the diverting action is related to a software application currently operating on the computing device. The diverting action may be stopping the application, exiting the application, uninstalling the application, and/or cancelling a process associated with the application. As a result, a notification may be sent to the administrator device responsive to identifying the diverting action and responsive to determining the software application is currently operating on the computing device. Next, a thwart command may be created and transmitted to the computing device to thwart the uninstall application operation. Also, a message may be created to inform the software application that an uninstall operation is being performed, and the message can be transmitted to the software application. The notification may include an unauthorized uninstall parameter. In addition, the application may retrieve a user profile associated with the computing device, and determine the user profile does not have uninstall privileges. In this case, the notification must be sent and the thwart command will be created.

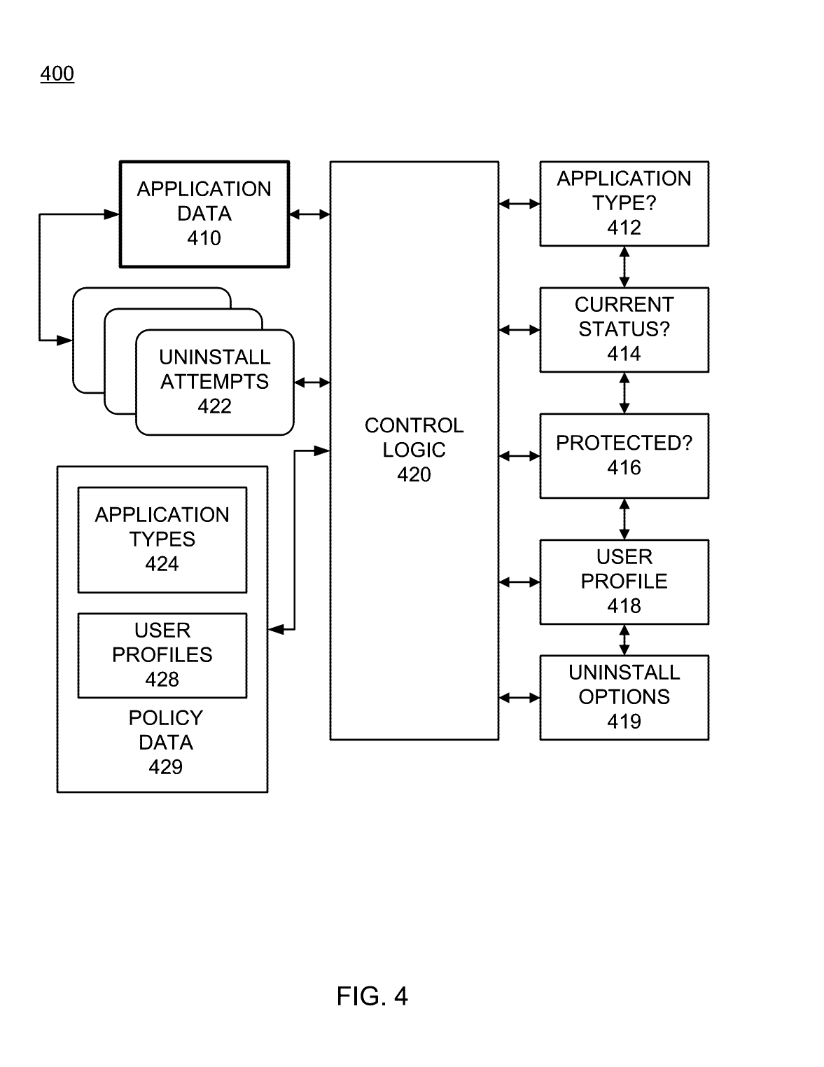

FIG. 4 illustrates an example uninstall data logic diagram according to example embodiments of the present application. Referring to FIG. 4, the logic diagram 400 may be a processor 420 that has various input parameters and various output parameters resulting from the computations. For example, the application data 410 may be periodic update messages which alert the control logic 420 to the ongoing status of the application (i.e., active, inactive, dormant, etc.). The various uninstall attempts 422 may be logged and received by the control logic 420. The attempts may invoke a lookup operation to determine the application types 424 which are protected or require authorization before uninstalling. Also, the user profiles 428 may be accessed to determine the user device status and the corresponding policies 429 associated with the user. Once the attempt is logged, the control logic may process an application type determination 412, a current status determination of the application 414, a protected status determination 416, a user profile audit 418 and then determine the uninstall options 419 permitted for this particular uninstall attempt. The options may include no access, partial uninstall access, full install access, etc.

In operation, the uninstallation functions attempt to connect to a running software product. If the connection fails then uninstallations software errors-out and quits without providing the user a chance to perform the uninstall. If the connection succeeds then the uninstallation application sends a message to the operating product that it is about to be uninstalled. The running product sends a final message to the controlling side, such as server-side running software that an unauthorized uninstall was just attempted. The controlling side can then generate and transmit a real-time notification to inform the administrator device that the product has been uninstalled or at least was attempted to be uninstalled.

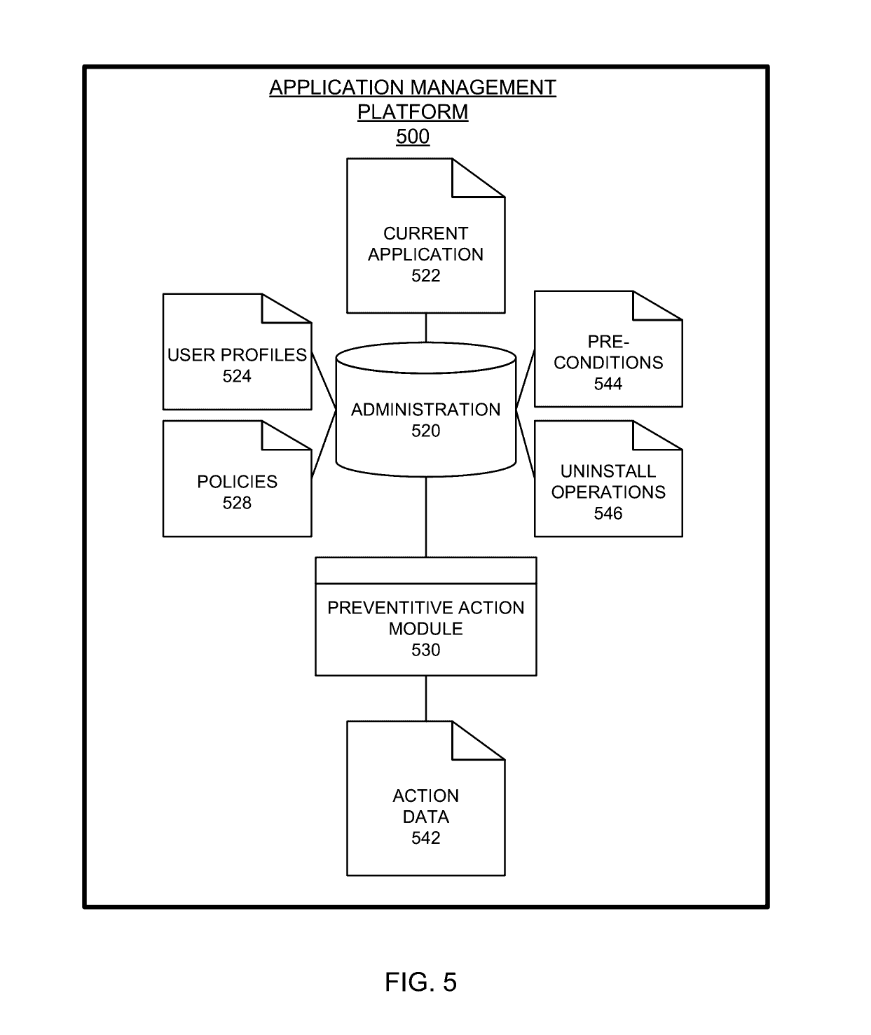

FIG. 5 illustrates an example application management platform according to the present application. Referring to FIG. 5, the application management platform 500 include various applications and datasets including the current application 522 that is attempting to be uninstalled, an administration databank 520 which includes all the various datasets including the user profiles 524, the pre-conditions associated with the various applications 544, the and enterprise policies 528 required by the enterprise and the uninstall operations 546 required logged and received by the platform. The preventative action module 530 can then process the datasets and select an action 542, such as reinstall, prevent uninstall, create a warning, thwart the uninstall, etc.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

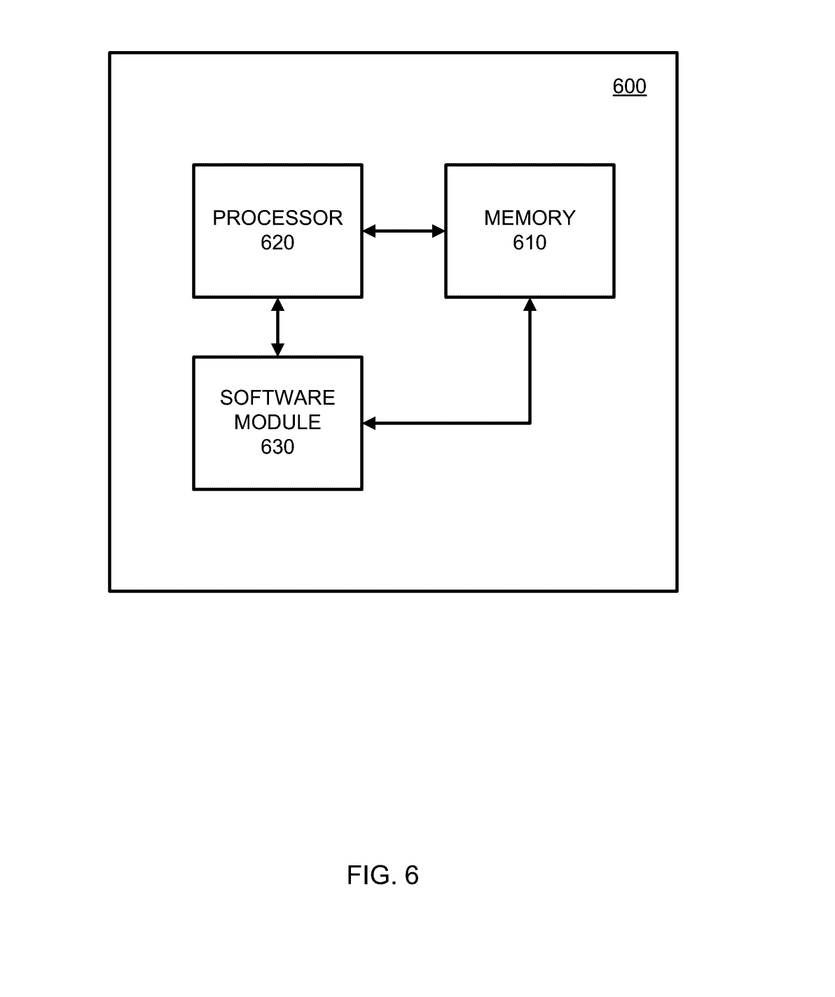

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 6 illustrates an example network element 600, which may represent any of the above-described network components, etc.

As illustrated in FIG. 6, a memory 610 and a processor 620 may be discrete components of the network entity 600 that are used to execute an application or set of operations. The application may be coded in software in a computer language understood by the processor 620, and stored in a computer readable medium, such as, the memory 610. The computer readable medium may be a non-transitory computer readable medium that includes tangible hardware components in addition to software stored in memory. Furthermore, a software module 630 may be another discrete entity that is part of the network entity 600, and which contains software instructions that may be executed by the processor 620. In addition to the above noted components of the network entity 600, the network entity 600 may also have a transmitter and receiver pair configured to receive and transmit communication signals (not shown).

Although an exemplary embodiment of the system, method, and computer readable medium of the present application has been illustrated in the accompanied drawings and described in the foregoing detailed description, it will be understood that the application is not limited to the embodiments disclosed, but is capable of numerous rearrangements, modifications, and substitutions without departing from the spirit or scope of the application as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments of the present application. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the application as discussed above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent, while remaining within the spirit and scope of the application. In order to determine the metes and bounds of the application, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
identifying a diverting action performed via a computing device managed by an administrator device on a computer network;
determining the diverting action is related to a software application currently operating on the computing device; and
transmitting a notification to the administrator device responsive to identifying the diverting action and responsive to determining the software application is currently operating on the computing device.

2. The method of claim 1, wherein the diverting action is an uninstall application operation.

3. The method of claim 2, further comprising:
creating a thwart command; and
transmitting the thwart command to the computing device to thwart the uninstall application operation.

4. The method of claim 2, further comprising:
creating a message to inform the software application that an uninstall operation is being performed; and
transmitting the message to the software application.

5. The method of claim 1, further comprising:
creating the notification via the software application to inform the administrator device.

6. The method of claim 5, wherein the notification comprises an unauthorized uninstall parameter.

7. The method of claim 6, further comprising:
retrieving a user profile associated with the computing device; and
determining the user profile does not have uninstall privileges.

8. An apparatus comprising:
a processor configured to
identify a divert action performed via a computing device managed by an administrator device on a computer network,
determine the divert action is related to a software application that currently operates on the computing device; and
a transmitter configured to transmit a notification to the administrator device responsive to the diverting action being identified and responsive to a determination that the software application currently operates on the computing device.

9. The apparatus of claim 8, wherein the divert action is an uninstall application operation.

10. The apparatus of claim 9, wherein the processor is further configured to create a thwart command, and the transmitter is further configured to transmit the thwart command to the computing device to thwart the uninstall application operation.

11. The apparatus of claim 9, wherein the processor is further configured to create a message to inform the software application that an uninstall operation is being performed, and the transmitter is further configured to transmit the message to the software application.

12. The apparatus of claim 8, wherein the processor is further configured to create the notification via the software application to inform the administrator device.

13. The apparatus of claim 12, wherein the notification comprises an unauthorized uninstall parameter.

14. The apparatus of claim 13, wherein the processor is further configured to retrieve a user profile associated with the computing device, and determine the user profile does not have uninstall privileges.

15. A non-transitory computer readable storage medium configured to store instructions that when executed cause a processor to perform:
identifying a diverting action performed via a computing device managed by an administrator device on a computer network;
determining the diverting action is related to a software application currently operating on the computing device; and
transmitting a notification to the administrator device responsive to identifying the diverting action and responsive to determining the software application is currently operating on the computing device.

16. The non-transitory computer readable storage medium of claim 15, wherein the diverting action is an uninstall application operation.

17. The non-transitory computer readable storage medium of claim 16, wherein the processor is further configured to perform creating a thwart command, and transmitting the thwart command to the computing device to thwart the uninstall application operation.

18. The non-transitory computer readable storage medium of claim 16, wherein the processor is further configured to perform:
creating a message to inform the software application that an uninstall operation is being performed; and
transmitting the message to the software application.

19. The non-transitory computer readable storage medium of claim 15, wherein the processor is further configured to perform:
creating the notification via the software application to inform the administrator device.

20. The non-transitory computer readable storage medium of claim 19, wherein the notification comprises an unauthorized uninstall parameter, and the processor is further configured to perform:
retrieving a user profile associated with the computing device; and
determining the user profile does not have uninstall privileges.
